(19) United States
(12) Patent Application Publication
(10) Pub. No.: US 2009/0244905 A1
(43) Pub. Date: Oct. 1, 2009

(54) ILLUMINATION DEVICE AND INPUT DEVICE WITH ILLUMINATION FUNCTION HAVING THE SAME

(75) Inventors: Hideyuki ISHIDA, Miyagi-ken (JP); Tsuyoshi HAYAMA, Miyagi-ken (JP); Hideaki NAGAKUBO, Miyagi-ken (JP); Koichi YAMAMOTO, Miyagi-ken (JP); Chiaki AIKAWA, Miyagi-ken (JP); Shozo TAKAMURA, Miyagi-ken (JP); Akira SAKAI, Miyagi-ken (JP); Makoto SASAKI, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/478,217

(22) Filed: Jun. 4, 2009

Related U.S. Application Data
(63) Continuation of application No. PCT/JP2007/073710, filed on Dec. 7, 2007.

(30) Foreign Application Priority Data
Dec. 11, 2006 (JP) 2006-333485

(51) Int. Cl. G09F 13/04; G02B 6/10; H01H 1/10

(52) U.S. Cl. 362/311.06; 385/129; 200/513

(57) ABSTRACT

In an input device with an illumination function including an illumination device having light-emitting diodes, strip-like light-guide plates that distribute light emitted from the light-emitting diodes to the side surfaces other than a light-incident surface, and a planar light-guide plate that is provided with a plurality of through-holes and laterally propagates light incident from the strip-like light-guide plates and emits the light from through-holes, the planar light-guide plate is provided with strip-like light-guide-plate providing grooves at portions where the through-holes are not provided, and the strip-like light-guide plates are provided in the strip-like light-guide-plate providing grooves such that the side surfaces of the strip-like light-guide-plate providing grooves and the side surfaces of the strip-like light-guide plates face each other.

### CLAIM OF PRIORITY

This application claims benefit of the Japanese Patent Application No. 2006-333485 filed on Dec. 11, 2006, which is hereby incorporated by reference.

### BACKGROUND OF THE INVENTION

1. Field of the Invention

The present invention relates to illumination devices for illuminating numeric keypads provided in portable phones and the like, and input devices with an illumination function having the same. In particular, it relates to means for uniformly illuminating a required illumination portion with a small number of light sources.

2. Description of the Related Art

A conventionally known input device with an illumination function provided in a portable phone and the like includes, as shown in FIG. 12, a printed board 101 on which a required wiring pattern including fixed electrodes 101a of push-button switches are formed, a light-guide plate 102 disposed on one side of the printed board 101, a plurality of light-emitting diodes 103 provided at side surfaces of the light-guide plate 102, movable electrodes 105 of push-button switches, which are accommodated in switch window holes 104 in the light-guide plate 102 and are composed of dome-like metal springs, a key sheet 107 having projections 106 formed at portions facing the movable electrodes 105, and translucent key tops 108 provided at portions corresponding to the projections 106 on the outer surface of the key sheet 107 (for example, refer to Japanese Unexamined Patent Application Publication No. 2005-268165).

In this input device with an illumination function, because light emitted from the light-emitting diodes 103 is guided by the light-guide plate 102 to the vicinity of the key tops 108 and is emitted at the switch window holes 104, the operation surface of the key tops 108 can be illuminated by the emitted light transmitted through the key sheet 107 and the key tops 108.

However, in the input device with an illumination function according to the above-mentioned known example, the light-guide plate 102 has multiple switch window holes 104 for accommodating the movable electrodes 105. Therefore, it is difficult to uniformly guide light emitted from the light-emitting diodes 103 to the back side of the switch window holes 104 as viewed from the light-emitting diodes 103. In order to uniformly illuminate all the key tops 108, a plurality of (in the above-mentioned known example, four) light-emitting diodes are inevitably needed. Accordingly, there are problems to be solved, such as an increase in the manufacturing cost of the device due to increased component count and assembly steps, an increase in size of the device, and large electric power consumption.

By using electroluminescence (EL) elements instead of the configuration using the light-guide plate 102 and the light-emitting diodes 103, all the key tops 108 can be uniformly illuminated. However, EL elements have disadvantages in that they are more expensive than light-emitting diodes, tend to generate electromagnetic noise, have poor long-term use reliability, and the like. Furthermore, if the EL elements are used as light emitters of an input device, contact portions have to be operated through the EL elements. This causes problems in that operation feeling of the key tops 108 is degraded and the long-term use reliability is further reduced because the EL elements are repeatedly pressed. Thus, the use of the EL elements as the light emitters of an input device is practically difficult.

### SUMMARY OF THE INVENTION

The present invention provides an illumination device that can uniformly illuminate a required illumination portion with a small number of light sources, and provides an input device with an illumination function that can provide high display quality with less electric power consumption.

To solve the above-described problems, first, the illumination device of the present invention includes: a point-like light source; a strip-like light-guide plate having a substantially strip-like shape, at least one side surface thereof serving as a light-incident surface, the strip-like light-guide plate distributing light emitted from the point-like light source and incident from the light-incident surface to the other side surfaces; and a planar light-guide plate that is substantially planar, at least one main surface thereof serving as a light-emitting surface, the planar light-guide plate laterally propagating light incident from the strip-like light-guide plate and emitting the light from the light-emitting surface. The planar light-guide plate has a strip-like light-guide plate providing groove, and the strip-like light-guide plate is provided in the providing groove such that the side surfaces other than the light-incident surface face side surfaces of the strip-like light-guide plate providing groove.

According to this configuration, because light emitted from the point-like light source can be incident in the planar light-guide plate through the strip-like light-guide plate, the light emitted from the point-like light source can be guided to the back side of the through-hole as viewed from the light-incident surface. Thus, the illuminance of light emitted from the required light-emitting surface can be made uniform with a small number of light sources. Furthermore, because the strip-like light-guide plate is provided in the providing groove formed in the planar light-guide plate, the illumination device can be made compact unlike the case where the strip-like light-guide plate is provided at a side surface of the planar light-guide plate.

Second, in the illumination device according to the above-described first configuration, the planar light-guide plate may be provided with a plurality of through-holes, and light may be emitted from openings of the plurality of through-holes in the light-emitting surface.

According to this configuration, because structures, such as contacts, can be disposed in the through-holes provided in the planar light-guide plate and light can be emitted from the through-holes, key tops etc. provided near the through-holes can be illuminated.

Third, in the illumination device according to the above-described first configuration, at least one main surface of the planar light-guide plate may have irregularities.

According to this configuration, the optical path of light incident from the point-like light source into the planar light-guide plate can be changed with the irregularities to make distribution of light emitted from the main surface uniform.

Fourth, in the illumination device according to the above-described first configuration, a plurality of the strip-like light-guide plates may be provided at different positions in the planar light-guide plate, and one or more point-like light sources may be disposed at an end of each of the plurality of strip-like light-guide plates.

According to this configuration, because a plurality of strip-like light-guide plates are used, arrangement of the strip-like light-guide plates with respect to the planar light-guide plate can be freely set. Thus, illuminance of light emitted from the respective portions of the light-emitting surface can be made uniform. Furthermore, because one or more point-like light sources are used for one strip-like light-guide plate, illuminance of the respective portions can be increased.

Fifth, in the illumination device according to the above-described first configuration, the planar light-guide plate may be provided with a strip-like light-guide plate with branched ends, and one or more point-like light sources may be disposed at a part of the strip-like light-guide plate.

According to this configuration, because the strip-like light-guide plate with branched ends is used, light can be uniformly propagated over a wide area of the planar light-guide plate using one strip-like light-guide plate. Thus, compared with a case where a plurality of strip-like light-guide plates are used, a cost reduction can be achieved by reduced component count.

Sixth, in the illumination device according to the above-described first configuration, a reflection surface that directs light propagated inside the planar light-guide plate and reached an edge back to the inside of the planar light-guide plate may be formed at the edge of the planar light-guide plate.

According to this configuration, because light propagated inside the planar light-guide plate and reached the edge of the planar light-guide plate can be reflected at the reflection surface formed at the corner back to the inside of the planar light-guide plate, loss of light emitted from the point-like light source can be reduced and the through-holes can be uniformly illuminated with high illuminance.

Seventh, in the illumination device according to the above-described first configuration, a plurality of prism grooves may be formed in the side surfaces of the strip-like light-guide plate other than the light-incident surface, the prism grooves each including a combination of a gentle slope portion and a steep slope portion that has a steeper gradient than the gentle slope portion and reflecting light emitted from the point-like light source to distribute the light in a longitudinal direction of the strip-like light-guide plate.

By forming a plurality of prism grooves in the side surfaces of the strip-like light-guide plate other than the light-incident surface, light emitted from the point-like light source is reflected at the prism grooves and is distributed in the longitudinal direction of the strip-like light-guide plate. Therefore, light emitted from the point-like light source can be converted into planar light equivalent to light emitted from a linear light source, making propagation of light along the plane of the planar light-guide plate uniform. Note that the light intensity distribution in the longitudinal direction of the strip-like light-guide plate can be adequately adjusted by adjusting the size and formation pitch of the prism grooves.

Eighth, in the illumination device according to the above-described first configuration, a reflection surface that totally reflects light emitted from the point-like light source and guides the light in a longitudinal direction of the strip-like light-guide plate may be formed between the light-incident surface of the strip-like light-guide plate and a side surface adjacent thereto.

According to this configuration, because light can be prevented from leaking from the vicinity of the portion where the point-like light source is provided, loss of light emitted from the point-like light source can be reduced, and the through-holes can be uniformly illuminated with high illuminance.

To solve the above-described problems, an input device with an illumination function of the present invention includes: a wiring board on which a required wiring pattern including a fixed contact of a push-button switch is formed; an illumination device including a point-like light source, a strip-like light-guide plate having a substantially strip-like shape, at least one side surface thereof serving as a light-incident surface, the strip-like light-guide plate distributing light emitted from the point-like light source and incident from the light-incident surface to the other side surfaces, and a planar light-guide plate that is substantially planar, at least one main surface thereof serving as a light-emitting surface, the planar light-guide plate laterally propagating light incident from the strip-like light-guide plate and emitting the light from the light-emitting surface; a plurality of metal domes that serve as movable contacts of push-button switches and are accommodated in through-holes; and a cover sheet having a plurality of actuators that individually press and operate the plurality of metal domes. The planar light-guide plate has a strip-like light-guide plate providing groove, and, the strip-like light-guide plate is provided in the providing groove such that the side surfaces other than the light-incident surface face side surfaces of the strip-like light-guide plate providing groove.

According to this configuration, because light emitted from the point-like light source can be incident laterally in the planar light-guide plate through the strip-like light-guide plate, the light emitted from the point-like light source can be guided to the back side of the through-hole as viewed from the light-incident surface. Accordingly, illuminance of light emitted from the required light-emitting surface can be made uniform, and illumination quality at the illumination portion of the input device with an illumination function can be improved. Furthermore, the strip-like light-guide plate is provided in the providing groove formed in the planar light-guide plate. Thus, unlike the case where the strip-like light-guide plate is provided at a side surface of the planar light-guide plate, the illumination device can be made compact, and, the input device with an illumination function can be made compact.

In the illumination device of the present invention, the strip-like light-guide plate providing groove is formed in the planar light-guide plate, and the strip-like light-guide plate that distributes light emitted from the point-like light source in the longitudinal direction is provided in the strip-like light-guide plate providing groove. This can make illuminance of light emitted from the through-holes uniform with a small number of light sources, and also can make the illumination device compact.

The input device with an illumination function of the present invention uses the illumination device including the point-like light source, the strip-like light-guide plate that distributes light emitted from the point-like light source to the side surfaces other than the light-incident surface, and the planar light-guide plate that has the strip-like light-guide plate providing groove and laterally propagates the light incident from the strip-like light-guide plate and emits the light from the required main surface. This can make illuminance of light emitted from the required main surface uniform with a small number of light sources, can improve the illumination quality at the illumination portion, can reduce the power consumption, and can make the illumination device compact. Accordingly, the input device with an illumination function can be made compact.

### BRIEF DESCRIPTION OF THE DRAWINGS

FIG. 1 is an exploded perspective view of an input device with an illumination function according to an embodiment;

FIG. 2 is an exploded side view of the input device with an illumination function according to the embodiment;

FIG. 3 is a sectional view of the input device with an illumination function according to the embodiment, in an assembled state;

FIG. 4 is a plan view of a planar light-guide plate and strip-like light-guide plates according to the embodiment;

FIG. 5 is a sectional view of a relevant part of the planar light-guide plate according to the embodiment, in which a metal dome is inserted;

FIG. 6 is a plan view showing the configuration and function of the strip-like light-guide plates according to the embodiment;

FIG. 7 is a plan view showing another example of the illumination device;

FIG. 8 is a plan view showing still another example of the illumination device;

FIG. 9 is a plan view showing still another example of the illumination device;

FIG. 10 is a plan view showing still another example of the illumination device;

FIG. 11 is a plan view showing still another example of the illumination device; and

FIG. 12 is an exploded side view of an input device with an illumination function according to a conventional example.

### DESCRIPTION OF THE PREFERRED EMBODIMENTS

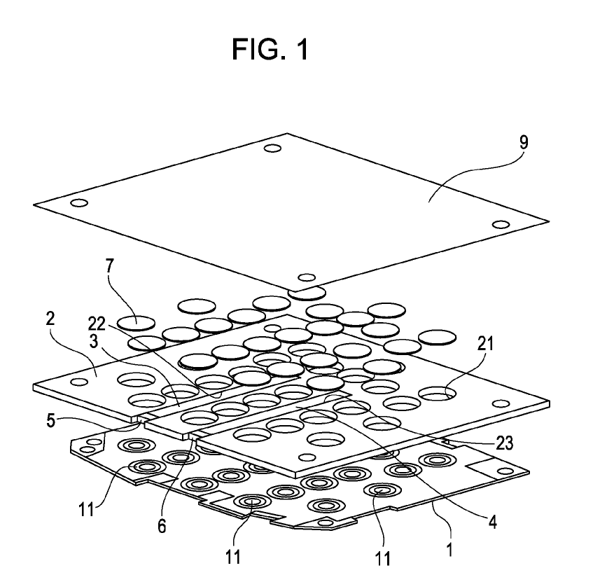

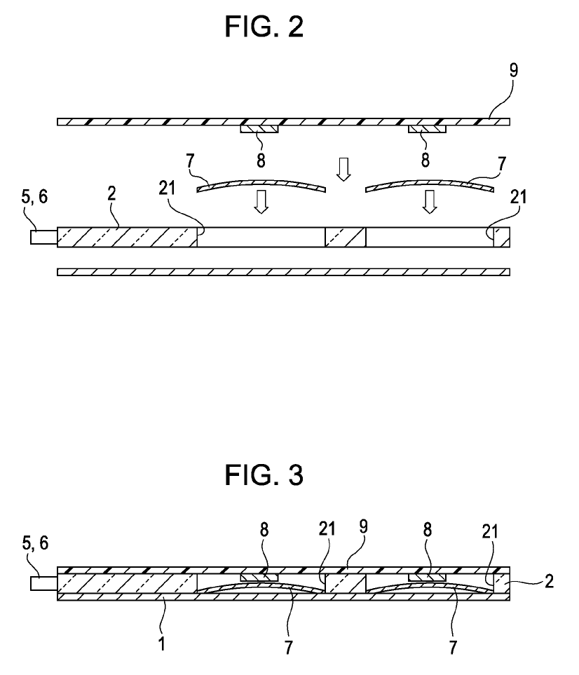

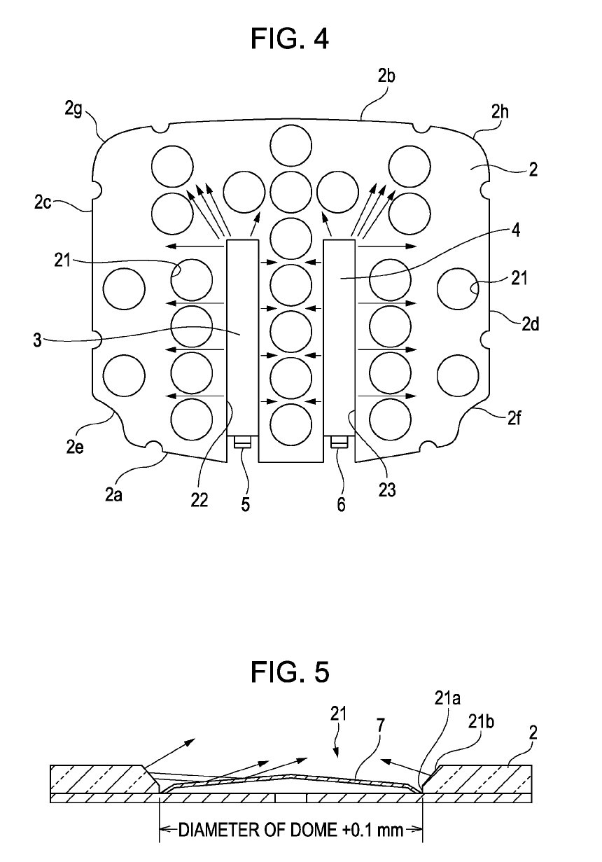

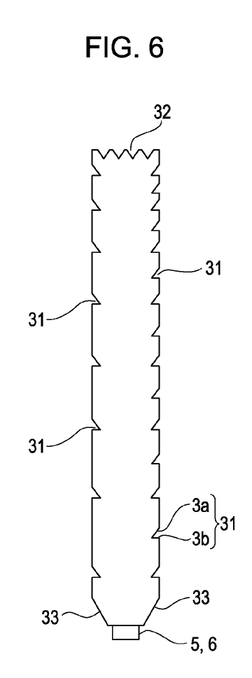

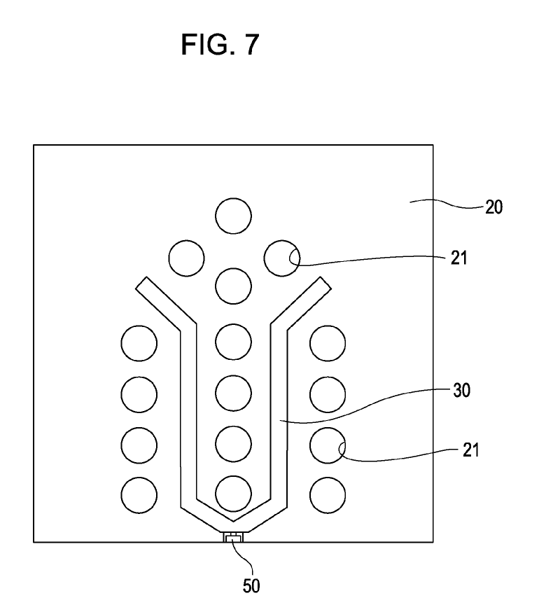

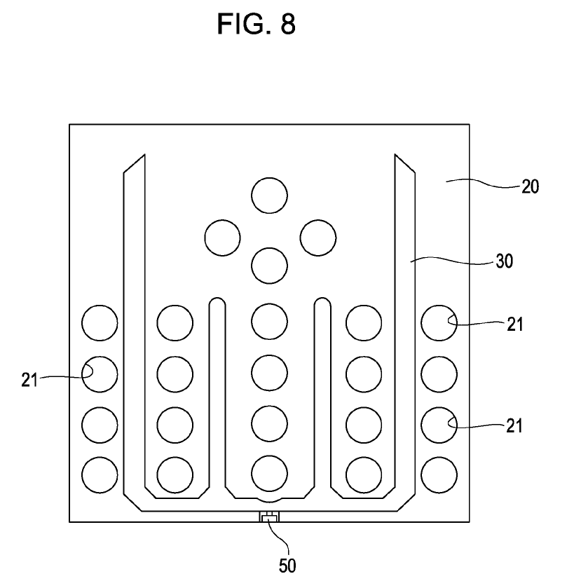

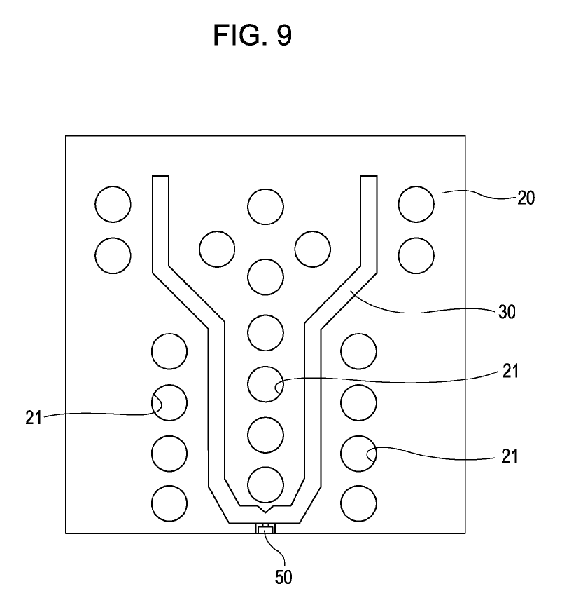

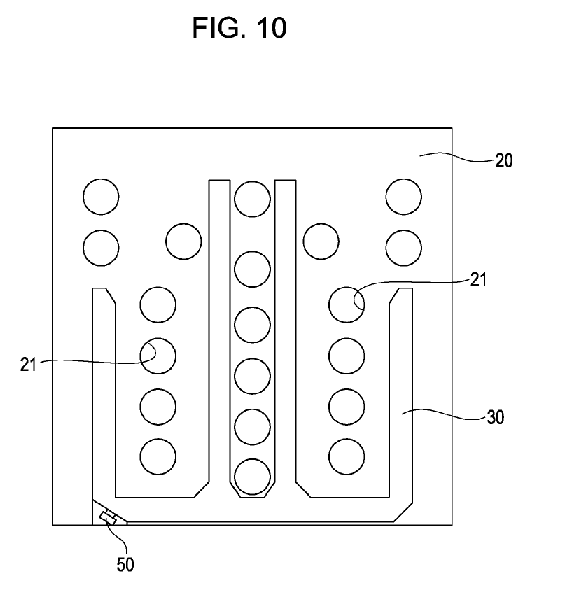

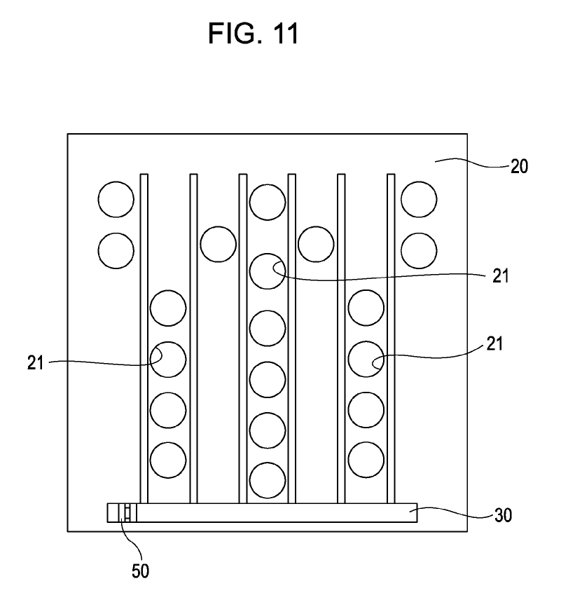

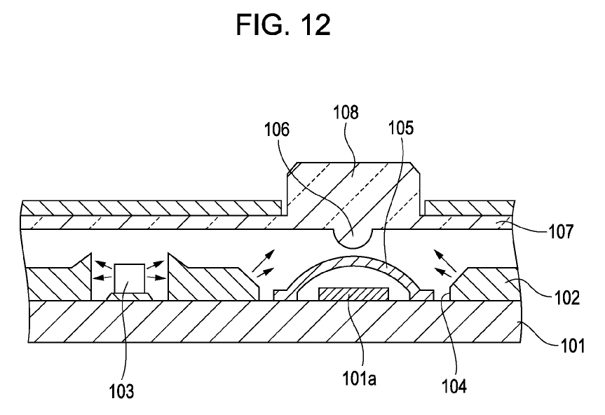

An illumination device and an input device with an illumination function having the same according to an embodiment of the present invention will be described with reference to FIGS. 1 to 11. FIG. 1 is an exploded perspective view of the input device with an illumination function according to an embodiment, FIG. 2 is an exploded side view of the input device with an illumination function according to the embodiment, FIG. 3 is a sectional view of the input device with an illumination function according to the embodiment in an assembled state, FIG. 4 is a plan view of a planar light-guide plate and strip-like light-guide plates according to the embodiment, FIG. 5 is a sectional view of a relevant part of the planar light-guide plate according to the embodiment, in which a metal dome is inserted, FIG. 6 is a plan view showing the configuration and function of the strip-like light-guide plate according to the embodiment, and FIGS. 7 to 11 are plan views of the illumination device according to the other embodiments.

As shown in FIGS. 1 to 3, the input device with an illumination function according to the embodiment mainly includes a wiring board 1 on which fixed contacts 11 and a required wiring pattern (not shown) are formed, a planar light-guide plate 2 in which a plurality of through-holes 21 and two strip-like light-guide-plate providing grooves 22 and 23 are provided, two strip-like light-guide plates 3 and 4 provided in the strip-like light-guide-plate providing grooves 22 and 23, two light-emitting diodes (point-like light sources) 5 and 6 disposed at one end of the strip-like light-guide plates 3 and 4, respectively, a plurality of metal domes 7 serving as movable contacts of push-button switches that make or break the fixed contacts 11, and a cover sheet 9 having actuators 8 that individually press and operate the metal domes 7.

It is desirable that at least a surface of the wiring board 1 to be in contact with the planar light-guide plate 2 be formed from a light-blocking white material to diffuse light emitted from the light-emitting diodes 5 and 6 to increase the evenness of light emitted from the through-holes 21. That is, because this configuration can restrict the wiring board 1 from absorbing light, loss of light emitted from the light-emitting diodes 5 and 6 can be reduced, and illuminance of the through-holes 21 can be increased. The wiring board 1 may be either a wiring board that is entirely made of a light-blocking white material or a wiring board that is made of a material other than a light-blocking white material and is covered by a cover layer made of a light-blocking white material. Examples of the light-blocking white material include reinforced plastic materials using liquid crystal polymer or polyimide as the base material, and rigid materials such as glass epoxy and low-temperature fired ceramic. According to the necessity, the wiring board 1 may have either a single-layer structure in which a conductor portion is formed only on the surface or a laminated structure in which multiple conductor portions are laminated with insulating layers interposed therebetween.

The planar light-guide plate 2 laterally guides the light incident from the strip-like light-guide plates 3 and 4 and is formed in a predetermined shape from a highly transparent resin material such as, for example, acrylic resin, polycarbonate resin, or cyclic polyolefin resin. The through-holes 21 accommodate the metal domes 7 and are formed at positions corresponding to the fixed contacts 11 formed on the wiring board 1. In contrast, the strip-like light-guide-plate providing grooves 22 and 23 are provided in portions where the through-holes 21 are not formed.

As shown in FIG. 4, the planar light-guide plate 2 of the this example has, as viewed from the positions where the light-emitting diodes 5 and 6 are provided, a side surface 2a on the near side and a side surface 2b on the depth side that are formed in an outwardly projecting arcuate shape, and left and right side surfaces 2c and 2d that are formed in a flat shape. A recessed arcuate surface is formed at two corners 2e and 2f on the near side, and a projected arcuate surface is formed at two corners 2g and 2h on the depth side. These side surfaces serve as light reflection surfaces. Accordingly, by making the planar light-guide plate 2 have such an external shape, light incident from the strip-like light-guide plates 3 and 4, propagated in the planar light-guide plate 2, and reached the edges of the planar light-guide plate 2 can be reflected at these edges and directed to the inner part of the planar light-guide plate 2. Thus, the loss of light emitted from the light-emitting diodes 5 and 6 can be reduced. The side surfaces of the planar light-guide plate 2 may be provided with a metal film composed of a highly reflective metal, such as aluminum or silver to increase the reflectivity. This can further reduce the loss of light emitted from the light-emitting diodes 5 and 6. Furthermore, at least one of the main surfaces of the planar light-guide plate 2 is provided with irregularities to guide the optical path of light incident from the light-emitting diodes 5 and 6 to the other main surface. This can increase the intensity of light emitted from a predetermined main surface and can increase the evenness thereof.

The thicker the planar light-guide plate 2 is, the more uniform the intensity of light emitted from the entire light-guide plate can be made. Thus, it is preferable that the thickness be 0.8 mm or greater, and it is more preferable that the thickness be 1.0 mm or greater. The brightness of one having a thickness of 1.2 mm or greater does not differ significantly from that of one having a thickness from 1.0 mm to 1.5 mm. Accordingly, from the standpoint of a reduction in thickness of the input device, it is preferable that the upper limit of the thickness be 1.2 mm.

As shown in FIG. 5, the through-holes 21 each include a positioning portion 21a of the metal dome 7, formed of a straight hole, and a light-emitting portion 21b formed as a bowl-shaped tapered hole with a gradient from 600 to 700. The diameter of the positioning portion 21a is set slightly larger than the outside diameter of the metal dome 7, e.g., about D+0.1 mm where D is the outside diameter of the metal dome 7. Because this can prevent misalignment of the metal domes 7 in the through-holes 21, the fixed contacts 11 formed on the wiring board 1 can be assuredly made or broken by the metal domes 7, and the reliability of the push-button switches can be increased. The reason why the gradient of the light-emitting portion 21b is set from 600 to 700 is because, as a result of a simulation, it is found that the amount of light emitted in the through-holes 21 can be increased most when the gradient of the through-holes 21 is set to an angle within this range.

The strip-like light-guide-plate providing grooves 22 and 23 are formed to have a size and shape that allow the strip-like light-guide plates 3 and 4 (described below) to be inserted therein with their side surfaces being in close contact with the inner surfaces thereof.

The strip-like light-guide plates 3 and 4 distribute light emitted from the light-emitting diodes 5 and 6 to the side surfaces other than the light-incident surfaces, allow the light to be incident laterally in the planar light-guide plate 2, are formed in a predetermined shape from a highly transparent resin material such as, similarly to the planar light-guide plate 2, acrylic resin, polycarbonate resin, or cyclic polyolefin resin, and are disposed in the strip-like light-guide-plate providing grooves 22 and 23.

As shown in FIG. 6, the strip-like light-guide plates 3 and 4 of this example have a substantially rectangular shape in plan view with one end surface serving as a light-incident surface through which light emitted from the light-emitting diode 5 or 6 enters. The strip-like light-guide plates 3 and 4 have a plurality of prism grooves 31, each including a combination of a gentle slope portion 3a and a steep slope portion 3b that has a steeper gradient than the gentle slope portion 3a, on the left and right side surfaces in the longitudinal direction. The prism grooves 31 reflect light emitted from the light-emitting diodes 5 and 6, distribute the light in the longitudinal direction of the strip-like light-guide plates 3 and 4, and emit it from the side surfaces on the opposite side. The size and formation pitch of the prism grooves 31 can be adequately adjusted according to the necessity. For example, to make the intensity of light to be distributed in the longitudinal direction of the strip-like light-guide plates 3 and 4 uniform, taking into consideration the attenuation of light, it is preferable that the prism grooves 31 closer to the tip have greater sizes or be formed at a narrower formation pitch. It is of course possible that the prism grooves 31 closer to the tip have greater sizes and are formed at a narrower formation pitch.

Furthermore, the strip-like light-guide plates 3 and 4 of this example have convex lenses 32 at the other end surface facing the light-incident surface. The convex lenses 32 change the optical path of light incident on the convex lenses 32 and radiate the light, and the size and the formation pitch thereof are adequately adjusted taking into consideration the direction in which the light is to be radiated, etc. Instead of the convex lenses 32, the prism grooves 31 may be formed at the aforementioned location.

Accordingly, the provision of the thus-configured strip-like light-guide plates 3 and 4 in the planar light-guide plate 2 enables light emitted from the light-emitting diodes 5 and 6 to be incident laterally in a required direction in the light-guide plate 2. Thus, light easily propagates to the back side of the through-holes 21 as viewed from the portions where the light-emitting diodes 5 and 6 are provided, and the intensity of light reaching the through-holes 21 can be made uniform.

In addition, as shown in FIG. 6, it is preferable that the strip-like light-guide plates 3 and 4 of this example be provided with, at the corners on the light-incident surface side, reflection surfaces 33 that totally reflect light emitted from the light-emitting diodes 5 and 6 and guide the light in the longitudinal direction of the strip-like light-guide plates 3 and 4. Because this prevents light from leaking from the vicinity of the portions where the light-emitting diodes 5 and 6 are provided, loss of light emitted from the light-emitting diodes 5 and 6 can be reduced, and the through-holes 21 can be uniformly illuminated with high illuminance.

The light-emitting diodes 5 and 6 are disposed at one end of the strip-like light-guide plates 3 and 4, respectively, so as to face each other. In the example shown, each of the strip-like light-guide plates 3 and 4 has only one light-emitting diode 5 or 6. However, the number of light-emitting diodes 5 and 6 is not limited thereto. Depending on the necessity, an adequate number of the light-emitting diodes 5 and 6 is provided. The greater the number of the light-emitting diodes 5 and 6, the more the illuminance of the illumination portion can be increased. Although the light-emitting diodes are used as the point-like light sources, the gist of the present invention is not limited thereto. Any known light sources may be used as long as they are compact light sources that emit diffused light.

The metal domes 7 function as the movable contacts of the push-button switches and are composed of a metal plate, for example, a stainless plate, that is formed in a bowl shape. The metal domes 7 may be, if necessary, plated with gold or silver on the electrode-contact side (inner surface side) thereof to establish good electric connection between themselves and the fixed contacts 11 and to improve the abrasion resistance. The metal domes 7 may also be, if necessary, plated with gold or silver or subjected to aluminum deposition on the outer surface to increase light reflectivity. The outer surfaces of the metal domes 7 may be either mirror-finished surfaces to increase the reflectivity or mat-finished surfaces to produce diffusion effect.

The actuators 8 press and operate the metal domes 7 and are arranged in a predetermined pattern on one side of the cover sheet 9. These actuators 8 may be formed from either a light-blocking white material or a transparent material. If the actuators 8 are formed from a light-blocking white material, an input device with an illumination function that selectively illuminates portions surrounding the actuators 8 can be obtained. On the other hand, if the actuators 8 are formed from a transparent material, an input device with an illumination function that illuminates the entire surfaces in the through-holes 21 including the portions where the actuators 8 are provided can be obtained.

The cover sheet 9 is formed from a highly elastic resin film, such as polyethylene terephthalate. The cover sheet 9 may be formed from a semi-transparent white material, a transparent material with a surface treated with light-diffusion treatment, or a transparent material. If the cover sheet 9 is formed from a semi-transparent white material or a transparent material with a surface treated with light-diffusion treatment, light emitted from the light-emitting diode 5 can be diffused at the surface of the cover sheet 9. Thus, the evenness of light emitted on the cover sheet 9 can be increased. On the other hand, if the cover sheet 9 is formed from a transparent material, the intensity of light transmitted through the cover sheet 9 can be increased. Thus, the brightness of the cover sheet 9 can be increased. The cover sheet 9 is bonded at the peripheral portion thereof to the peripheral portion of the planar light-guide plate 2 via an adhesion layer.

A method for assembling the input device with an illumination function of this example will be described below. First, the following are prepared: the wiring board 1 in which the light-emitting diodes 5 and 6 are mounted at predetermined positions; the planar light-guide plate 2; the strip-like light-guide plates 3 and 4; the metal domes 7; and the cover sheet 9 to one surface of which the actuators 8 arranged in a predetermined pattern are attached. Then, the planar light-guide plate 2 is positioned relative to and attached to a fixed-terminal forming surface of the wiring board 1. Thus, the fixed terminals 11 formed on the wiring board 1 are disposed in the through-holes 21 provided in the planar light-guide plate 2. Adhesion, snap connection, etc. may be used to assemble the wiring board 1 and the planar light-guide plate 2. Next, the strip-like light-guide plates 3 and 4 are provided in the strip-like light-guide-plate providing grooves 22 and 23 formed in the planar light-guide plate 2. As a result, the light-emitting diodes 5 and 6 mounted on the wiring board 1 are automatically located at positions facing the light-incident surfaces of the strip-like light-guide plates 3 and 4, respectively. The strip-like light-guide plates 3 and 4 may be provided in the planar light-guide plate 2 by insertion or fitting. Then, the metal domes 7 are accommodated in the through-holes 21 provided in the planar light-guide plate 2 so as to project upward. Finally, while the tips of the actuators 8 are abutted against or brought close to the top portions of the metal domes 7, the cover sheet 9 is adhered to the surfaces of the planar light-guide plate 2 and the strip-like light-guide plates 3 and 4.

In the input device with an illumination function of this example, the strip-like light-guide plates 3 and 4 are provided in the planar light-guide plate 2, and light emitted from the light-emitting diodes 5 and 6 is incident in the planar light-guide plate 2 through the strip-like light-guide plates 3 and 4. Thus, as shown in FIG. 4, light emitted from the light-emitting diodes 5 and 6 can be guided to the back side of one or more through-holes 21 as viewed from the positions where the light-emitting diodes 5 and 6 are provided. Accordingly, illuminance of light emitted from the through-holes 21 can be made uniform with a small number of light-emitting diodes, and illumination quality at the illumination portion of the input device with an illumination function can be improved. In particular, because two strip-like light-guide plates 3 and 4 are used and the light-emitting diodes 5 and 6 are provided respectively for the strip-like light-guide plates 3 and 4, illuminance of light emitted from the through-holes 21 can be increased and can be made further uniform. Furthermore, in the input device with an illumination function of this example, the strip-like light-guide plates 3 and 4 are provided in the strip-like light-guide-plate providing grooves 22 and 23 formed in the planar light-guide plate 2. Therefore, unlike the case where the strip-like light-guide plates are disposed at the side surfaces of the planar light-guide plate 2, the illumination device including the planar light-guide plate 2, the strip-like light-guide plates 3 and 4, and the light-emitting diodes 5 and 6 can be made compact, and the input device with an illumination function can be made compact.

Although two strip-like light-guide plates 3 and 4 are used in the above-described embodiment, as shown in FIGS. 7 to 11, a configuration in which a strip-like light-guide plate 30 with branched ends is provided in a planar light-guide plate 20 is also possible. In such a configuration, the component count can be reduced compared with a case where a plurality of strip-like light-guide plates are used. Thus, the costs of the illumination device, and hence, of the input device with an illumination function, can be reduced. Although only one light-emitting diode 50 is provided in the examples of FIGS. 7 to 11, the number of light-emitting diodes 50 to be provided is not limited thereto, and an adequate number of light-emitting diodes 50 may be provided according to the necessity.

The above-described embodiment has a configuration in which the separately formed actuator 8 and cover sheet 9 are bonded later. However, the gist of the present invention is not limited thereto, and, for example, a cover sheet with actuators obtained by, for example, injection molding, may also be used.

What is claimed is:

1. An illumination device comprising:
a point-like light source;
a strip-like light-guide plate having a substantially strip-like shape, at least one side surface thereof serving as a light-incident surface, the strip-like light-guide plate distributing light emitted from the point-like light source and incident from the light-incident surface to the other side surfaces; and
a planar light-guide plate that is substantially planar, at least one main surface thereof serving as a light-emitting surface, the planar light-guide plate laterally propagating light incident from the strip-like light-guide plate and emitting the light from the light-emitting surface,
wherein the planar light-guide plate has a strip-like light-guide plate providing groove, and
wherein the strip-like light-guide plate is provided in the providing groove such that the side surfaces other than the light-incident surface face side surfaces of the strip-like light-guide plate providing groove.

2. The illumination device according to claim 1,
wherein the planar light-guide plate is provided with a plurality of through-holes, and
wherein light is emitted from openings of the plurality of through-holes in the light-emitting surface.

3. The illumination device according to claim 1,
wherein at least one main surface of the planar light-guide plate has irregularities.

4. The illumination device according to claim 1,
wherein a plurality of the strip-like light-guide plates are provided at different positions in the planar light-guide plate, and
wherein one or more point-like light sources are disposed at an end of each of the plurality of strip-like light-guide plates.

5. The illumination device according to claim 1,
wherein the planar light-guide plate is provided with a strip-like light-guide plate with branched ends, and
wherein one or more point-like light sources are disposed at a part of the strip-like light-guide plate.

6. The illumination device according to claim 1,
wherein a reflection surface that directs light propagated inside the planar light-guide plate and reached an edge back to the inside of the planar light-guide plate is formed at the edge of the planar light-guide plate.

7. The illumination device according to claim 1,
wherein a plurality of prism grooves are formed in the side surfaces of the strip-like light-guide plate other than the light-incident surface, the prism grooves each including a combination of a gentle slope portion and a steep slope portion that has a steeper gradient than the gentle slope portion and reflecting light emitted from the point-like light source to distribute the light in a longitudinal direction of the strip-like light-guide plate.

8. The illumination device according to claim 1,
wherein a reflection surface that totally reflects light emitted from the point-like light source and guides the light in a longitudinal direction of the strip-like light-guide plate is formed between the light-incident surface of the strip-like light-guide plate and a side surface adjacent thereto.

9. An input device with an illumination function comprising:
a wiring board on which a required wiring pattern including a fixed contact of a push-button switch is formed;
an illumination device including a point-like light source, a strip-like light-guide plate having a substantially strip-like shape, at least one side surface thereof serving as a light-incident surface, the strip-like light-guide plate distributing light emitted from the point-like light source and incident from the light-incident surface to the other side surfaces, and a planar light-guide plate that is substantially planar, at least one main surface thereof serving as a light-emitting surface, the planar light-guide plate laterally propagating light incident from the strip-like light-guide plate and emitting the light from the light-emitting surface;
a plurality of metal domes that serve as movable contacts of push-button switches and are accommodated in through-holes; and
a cover sheet having a plurality of actuators that individually press and operate the plurality of metal domes,
wherein the planar light-guide plate has a strip-like light-guide plate providing groove, and
wherein the strip-like light-guide plate is provided in the providing groove such that the side surfaces other than the light-incident surface face side surfaces of the strip-like light-guide plate providing groove.
